(19) United States
(12) Patent Application Publication
(10) Pub. No.: US 2012/0273512 A1
(43) Pub. Date: Nov. 1, 2012

(54) Etched Pot Lid

(76) Inventor: Jie Dai, Jordon (CN)

(21) Appl. No.: 13/338,856

(22) Filed: Dec. 28, 2011

(30) Foreign Application Priority Data
Apr. 28, 2011 (CN) 201130091576.8

(51) Int. Cl. A47J 36/12

(52) U.S. Cl. 220/832; 220/212.5; 220/845

(57) ABSTRACT

A double layer lid for a cookware includes a top glass layer having a top glass layer top surface and a top glass layer bottom surface. A bottom glass layer has a bottom glass layer top surface and a bottom glass layer bottom surface. A handle is mounted to the top glass layer. A rim has a top section retaining the top glass layer and a lower section retains the bottom glass layer. A top edge is formed on the rim at a top portion of the rim and a bottom edge is formed on the rim at a bottom portion of the rim. The top glass layer bottom surface is etched with a groove or the bottom glass layer top surface is etched with a groove. The top glass layer is installed over the bottom glass layer.

This application claims priority from Jie Dai, U.S. application Ser. No. 13/274,195 filed Oct. 14, 2011 and claims priority from inventor Jie Dai's U.S. patent application Ser. No. 13/217,894 filed Aug. 25, 2011 entitled double layer pot lid, which in turn claim priority from Chinese patent application 201130091576.8 filed Apr. 28, 2011, the disclosures of which are incorporated herein by reference.

### BACKGROUND OF THE INVENTION

A. Field of the Invention

The present invention relates to double layer lids for cookware.

B. Description of the Prior Art

Traditionally, most pot lids have been single layer and made of transparent glass or made on a sheet of aluminum or steel. Since heat rises, most of the heat during cooking escapes through the top opening of the cooking vessel. Although double layer cooking vessel lids have been made in the past, improvements can still be made to be construction of the double layer lid. Current cooking pots are formed by a pot body and a pot lid matched with the pot body, the pot body and the lid are independent to each other and without any connection, the lid just is directly taken off to expose the pot body. This makes the lid is inconvenient to place and often falls in haste cooking. The structure of the lid swiveling mechanism of the current cooking pot with a lid swiveling mechanism is too complicated, and the pot body is fixedly connected with the lid when having the lid swiveling mechanism, making the pots are difficult to clean because the lids can not be taken off.

### SUMMARY OF THE INVENTION

A double layer lid for a cookware includes a top glass layer having a top glass layer top surface and a top glass layer bottom surface. A bottom glass layer has a bottom glass layer top surface and a bottom glass layer bottom surface. A handle is mounted to the top glass layer. A rim has a top section retaining the top glass layer and a lower section retains the bottom glass layer. A top edge is formed on the rim at a top portion of the rim and a bottom edge is formed on the rim at a bottom portion of the rim. The top glass layer bottom surface is etched with a groove or the bottom glass layer top surface is etched with a groove. The top glass layer is installed over the bottom glass layer.

The lower section retains the bottom glass layer top surface underneath a lower section horizontal wall formed on the lower section, and the lower section retains the bottom glass layer bottom surface above a bottom crimp formed on the lower section. The lower section retains a bottom glass layer outer periphery inside a lower section vertical wall formed on the lower section. The upper section vertical wall is formed on the upper section. The upper section vertical wall retains a top glass layer outer periphery. The top edge retains the top glass layer top surface. The intermediate indent is formed on the lower section, and the intermediate indent extends inward between the top glass layer and the bottom glass layer. The top seal seals the top edge to the top glass layer top surface. The bottom seal that seals the bottom glass layer top surface to the lower section.

An object of the present invention is to overcome the defects of the prior art and provide a detachable lid swiveling mechanism for pot lid with simple structure and convenient disassembly.

In order to solve the problems of the prior art, the detachable lid swiveling mechanism for a pot lid of the present invention comprises a base disposed on a pot body and a connecting piece arranged on a pot lid. The pot body has a pot handle with an upper surface. A base is disposed on the upper surface of the pot handle of the pot body. The base is provided with a blocking slot having an insertion inlet, and the connecting piece is provided with a rotating shaft capable of movably passing in and out the blocking slot through the insertion inlet and matching with the blocking slot to enable the pot lid to rotate around the blocking slot.

The connecting piece is provided with a U-shaped rotating shaft seat which unites with the edge of the connecting piece to form a limiting structure is arranged on the connecting piece. The U-shaped rotating shaft seat is provided with two limiting arms for preventing the rotating shaft from sliding out the blocking slot, and the rotating shaft is disposed between the two limiting arms.

The tail end of the connecting piece is a limiting part which is buckle-connected to the outer wall of the blocking slot to enable the pot lid to erect on the pot body.

The base is disposed on a pot lug.

The connecting piece is provided with a mounting hole for facilitating connection between the connecting piece and the pot lid.

Compared with the prior art, the present invention has the following advantages:

The lid swiveling mechanism of the present invention makes the pot lid movably connected with the pot body by fitting the connecting piece to the base. The use is convenient because the blocking slot of the lid swiveling mechanism of the present invention is provided with an insertion inlet through which the pot lid is easily connected with and detached from the pot body, thereby greatly increasing the flexibility of connection between the pot lid and the pot body and effectively solving the problem of difficult cleaning of the current cooking pot with lid swiveling mechanism. The lid swiveling mechanism of the present invention has a simple structure, low manufacturing cost and complete functions, and is suitable for being mounted on any cooking pot.

### BRIEF DESCRIPTION OF THE DRAWINGS

FIG. 1 is a cross section view of the double layer lid.

FIG. 2 is a top perspective view of the double layer lid.

FIG. 3 is a structural diagram of the present invention.

FIG. 4 is a structural diagram of the connecting piece.

FIG. 5 is a structural diagram of the present invention connecting to a pot lid.

FIG. 6 is a structural diagram of the present invention connecting to a cooking pot.

FIG. 7 is a cross-section diagram of etched glass design.

FIG. 8 is a top view of etched glass design showing flat pot lid glass.

FIG. 9 is a side view of the etched glass design showing the mold.

FIG. 10 is a top view of the etched glass design showing a curved pot lid glass.

FIG. 11 is a side view of the curved etched glass.

FIG. 12 is a sample design etched on the pot lid glass.

Similar reference numbers denote corresponding features throughout the attached drawings. The following call a list of elements can be a useful guide in referencing the elements of the drawings.
20 Double Glass Layer
21 Top Glass Layer
22 Bottom Glass Layer
23 Top Seal
24 Bottom Seal
28 Handle Mount Opening
30 Upper Section
31 Top Edge
32 Top Bend
33 Rim Top Face
34 Rim Tip
35 Rim Bottom Face
36 Rim Inside Corner
37 Upper Section Vertical Wall
38 Upper Section Corner
39 Upper Section Horizontal Wall
40 Lower Section
42 Intermediate Indent
43 Lower Section Horizontal Wall
44 Lower Section Vertical Wall
45 Lower Crimp
46 Bottom Edge
50 Handle
51 Handle Grip
52 Handle Frame
53 Shaft Of Connector
54 Nut
55 Handle Flange
56 Top Washer
57 Bottom Washer
101 Base
102 Connecting Piece
103 Pot Body
104 Pot Lid
105 Blocking Slot
106 Pot Lug
107 U-Shaped Rotating Shaft Seat
108 Mounting Hole
121 Limiting Part
151 Insertion Inlet
161 Connecting Part
171 Limiting Arms
172 Rotating Shaft
220 Glass Sheet
221 Etched Groove
231 Mold Concave Profile
232 Mold Body

### DETAILED DESCRIPTION OF THE PREFERRED EMBODIMENT

The present invention is a double layer lid having a double glass layer 20 that includes a top glass layer 21 and a bottom glass layer 22. The double layer lid also includes an upper section to secure the top glass layer 21 and a bottom section to secure the bottom glass layer 22. The top glass layer is sealed to the upper section at the top seal 23 and the bottom glass layer is sealed to the bottom section 40 at a bottom seal 24. The top seal 23 and a bottom seal 24 are made as an elastomeric material applied to the construction or can be an o-ring that is prefabricated and pressed to retain against the construction during assembly.

The top glass layer 21 is preferably formed as an arched dome shaped piece of glass. The bottom glass layer 22 is also preferably formed as an arched dome shaped piece of glass. The top glass layer 21 has a lower external periphery about its circumference. The bottom glass layer 22 similarly has a lower external periphery about its circumference.

The upper section of the rim begins at a top edge 31 which faces inward toward the middle of the lid. The top edge 31 preferably receives a top seal 23 to seal the top edge 31 against the top glass layer 21. The top edge 31 may include a top bend 32 to provide resilient biasing of the top edge 31 against the top glass layer 21. The top bend 32 can be formed as a protrusion on the upper section so that the material is protruding upward at the top bend 32.

The rim top face 33 is preferably substantially horizontal terminating at a rim tip 34. The rim bottom face 35 is folded underneath the rim tip 34 and extends horizontally underneath the rim top face 33. The rim inside corner 36 bends underneath the rim bottom face 35. The rim inside corner 36 defines an external periphery of the top glass layer 21. The outer periphery of the top glass layer abuts and is retained by the upper section vertical wall 37 and the upper section horizontal wall 39. The upper section vertical wall 37 joins to the upper section horizontal wall 39 at the upper section corner 38. The top glass layer 21 is therefore retained underneath the top edge 31 on top, retained inside the upper section vertical wall 37, and retained above the upper section vertical wall 39.

The lower section 40 continues from the upper section 30 and includes an intermediate indent. An intermediate indent 42 is formed as a generally rectangular indent shape so that the rim has the indent area which extends in between the top glass layer 21 and the bottom glass layer 22. The indent may further receive an o-ring seal to provide a seal between the lid and a pot or kettle. The indent may also receive a plastic ring bushing which may provide decreased friction between the lid and an internal upper surface of a pot.

The lower section 40 includes a lower section horizontal wall 43 extending outward from the intermediate indent 42. The lower section vertical wall 44 meets the lower section horizontal wall 43. The lower end of the lower section vertical wall 44 receives a lower crimp 45. The end of the lower crimp 45 is the bottom edge 46. The bottom edge 26 is the bottom edge of the rim that opposes the top edge 31, which is the top edge of the rim.

The lower section 40 of the rim retains the bottom glass layer 22 by retaining top surface of the bottom glass layer 22 underneath the lower section horizontal wall 43. The lower section 40 of the rim retains the bottom glass layer 22 by retaining the bottom surface of the bottom glass layer 22 above the bottom edge 46 and above the bottom crimp 45. The lower section 40 of the rim retains the bottom glass layer 22 by retaining the outer periphery of the bottom glass layer 22 inside the lower section vertical wall 44. The terms horizontal and vertical refer to constructions which are generally horizontal and generally vertical. The overall construction of the rim is possible with variations of angle from that shown in the drawings.

The double layer lid has a handle mounted to the top surface of the double layer lid. The top surface of the double layer lid is the double glass layer 20. The top glass layer 21 of the double glass layer 20 has a pair of handle mount openings 28 formed through the top glass layer 21. The handle mount openings 28 are preferably circular in cross-section so that they receive a circular shaft of a connector 53. The shaft of the connector 53 passes through the handle mount openings 28, and preferably a pair of connector shaft 53 are passed through the pair of handle mount openings 28. The shaft of the connector 53 can be connected to a nut 54 to provide tightening, but not over tightening.

It is possible that the shaft of the connector 53 does not touch the inside surface of the handle mount opening 28. A top washer 56 is preferably made of elastomeric material but could also be made of metal and the top washer may provide a seal between the handle mount opening and the top washer 56. The top washer 56 is placed above the top glass layer and comes in contact with the top surface of the top glass layer. The bottom washer 57 is preferably placed below the top glass layer and comes in contact with the bottom surface of the top glass layer. The bottom washer 57 can also be made of or include a layer of an elastomeric material so as to provide a seal between the shaft of connector 53 and the handle mount opening 28.

The handle 50 includes a handle grip 51 mounted to a handle frame 52. The handle frame 52 includes a pair of handle flange 55 extending outward from the handle frame 52 at a lower end of the handle frame 52. The pair of handle flange 55 extends in opposite directions from the handle frame 52. Each of the handle flange 55 has an opening to match the handle mount opening 28 of the top glass layer 21. The shaft of connector 53 passes through the handle flange opening and the handle mount opening 28 so that the handle flange 55 is secured to the top glass layer 21.

The method of manufacturing the rim construction can be to use stainless steel to make a rim. Assembly may begin by inserting the bottom glass layer 22 from the bottom opening of the rim until it abuts the intermediate indent, then applying the bottom seal 24. Once the bottom glass layer 22 is sealed, the crimp 45 retains the bottom glass layer 22. The top glass layer is inserted into the top opening of the rim until it abuts the intermediate indent, and then pulling the rim top face 33, the top bend 32 and the top edge 31 to close the top edge 31 to the top glass layer 21. The top seal 23 can be applied in the final step. Other steps for construction can be used for making this device.

The hinge is preferably a detachable lid swiveling mechanism.

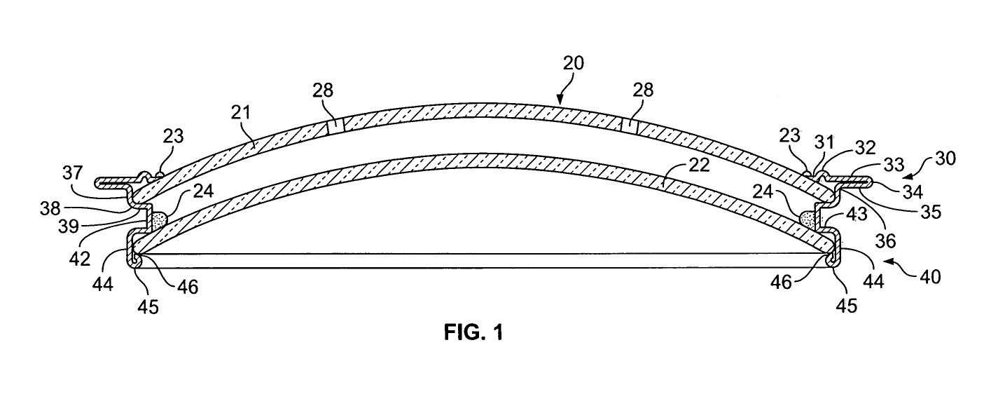

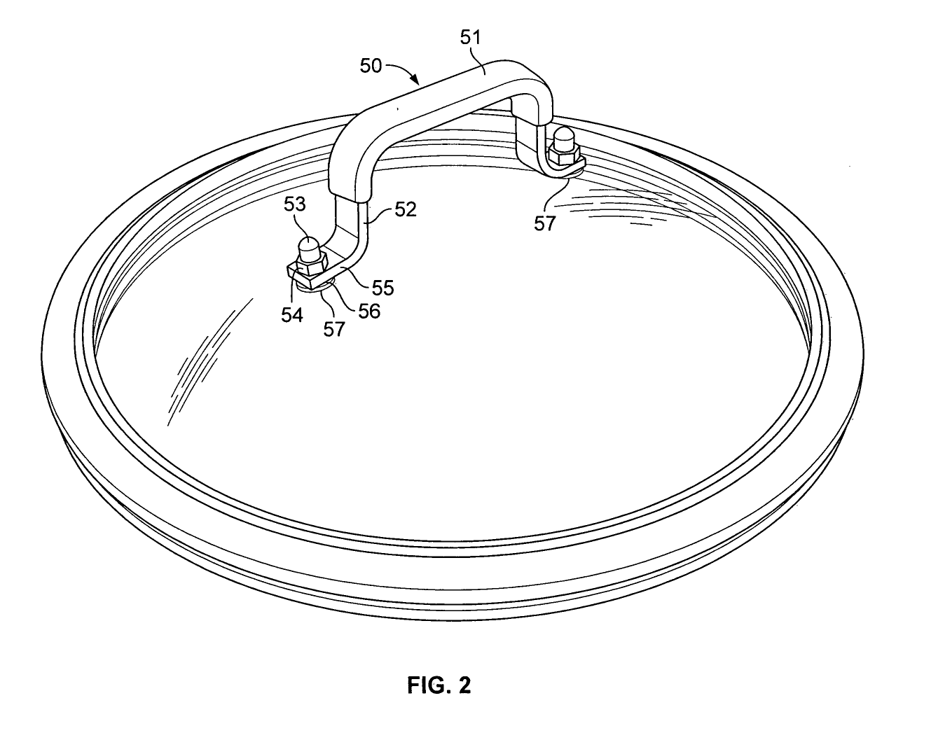

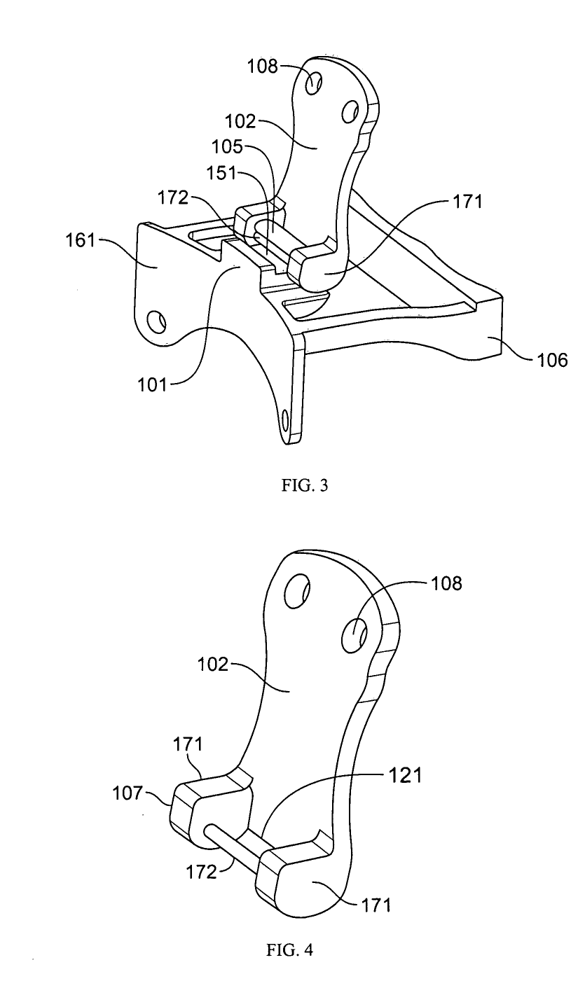

As shown in FIG. 1 to FIG. 3, a detachable lid swiveling mechanism for pot lid of the present invention comprises a base 101 and a connecting piece 102. The base 101 is disposed on a pot body 103, and the connecting piece 102 is arranged on a pot lid 104.

Referring to FIG. 1, the base 101 is provided with a blocking slot 105 having an insertion inlet 151, and a rotating shaft 172 of the connecting piece 102 can pass in and out the blocking slot 105 through the insertion inlet 151. In order to simplify the structure and reduce the working processes, the base 101 is arranged at a connecting part 161 of a pot lug 106.

One end of the connecting piece 102 is provided with a mounting hole 8 for facilitating connection between the connecting piece 102 and the pot lid 104. The other end is provided with a U-shaped rotating shaft seat 107 which has two limiting arms 171 for preventing the rotating shaft 172 from sliding out the blocking slot 5, and as shown in FIG. 2, the rotating shaft 172 is disposed between the two limiting arms 171.

When the pot lid 4 needs to be connected to the pot body 3, the rotating shaft 172 can be put into the blocking slot 5 through the insertion inlet 151 and rotates by taking a hinge joint part as a pivot, a limiting part 121 at the tail end of the connecting piece 102 unites with the two limiting arms 171 to form a limiting structure, the two limiting arms 171 can prevent the rotating shaft 172 from sliding out the blocking slot 105 to enable the structure of the present invention to be more stable. The limiting part 121 is buckle-connected with the outer wall of the blocking slot 105 when the connecting piece 121 rotates around the blocking slot 105 till the pot lid 104 is erect on the pot body 103. As shown in FIG. 4, the pot lid 102 can be erect on the pot body 103 when being opened, and thus the use is very convenient. The rotating shaft 172 is removed from the blocking slot 105 during cleaning.

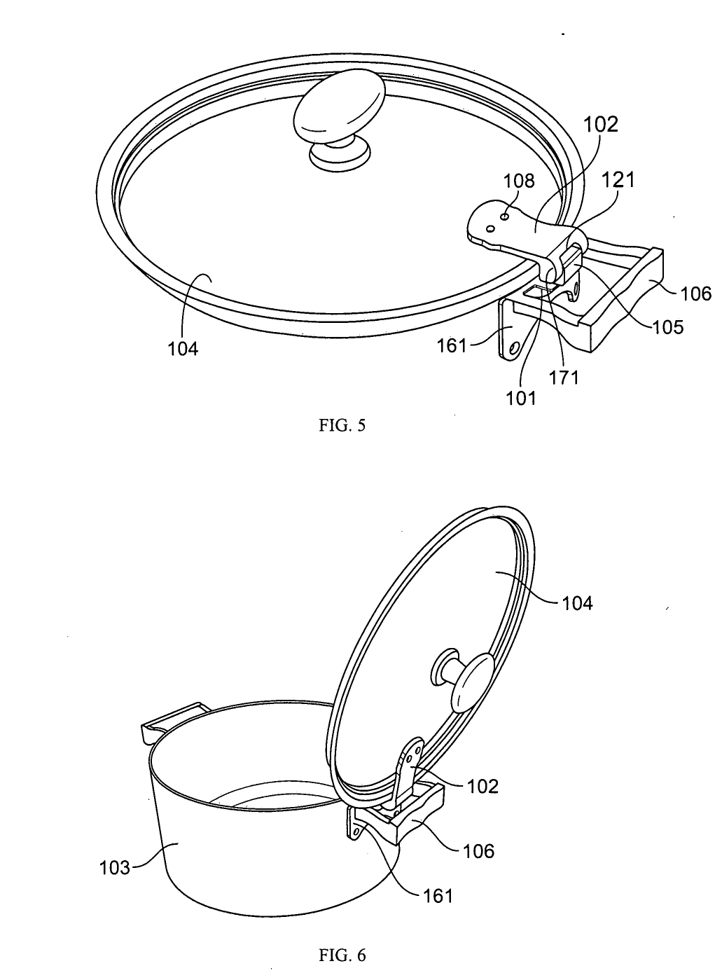

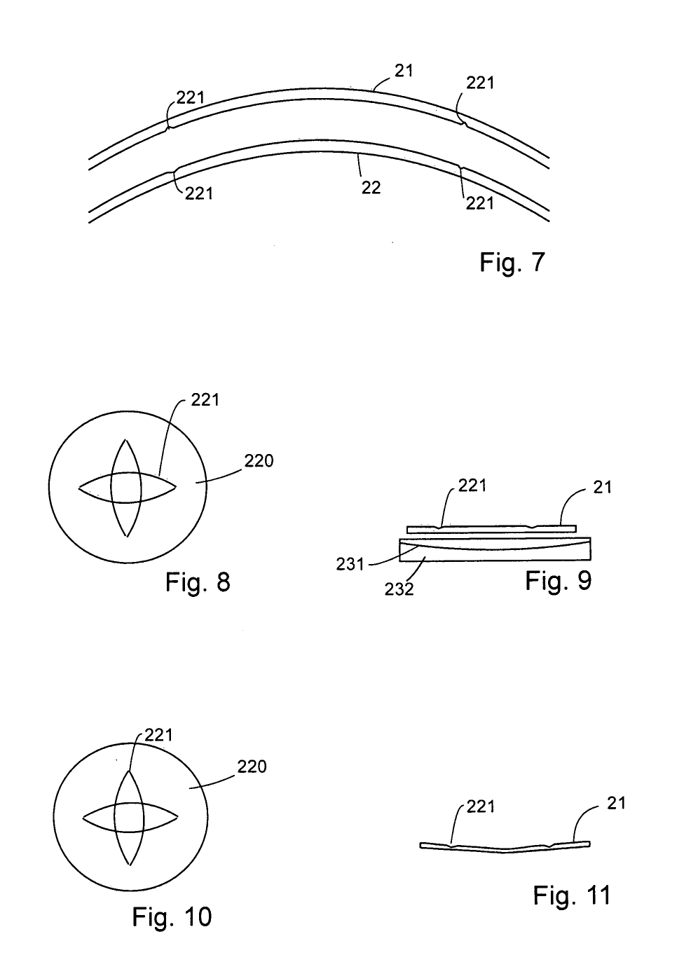

Optionally, the glass of the pot lid can be etched FIGS. 7-11. The pot lid glass is preferably formed as a glass sheet 220 and can be the top glass layer 21 or the bottom glass layer 22. As seen in FIG. 7, it is possible to have etching on both the lower surface of the top glass layer 21 and the upper surface of the bottom glass layer 22. The glass etching can be formed on a lower surface of the top glass layer 21 or on an upper surface of the bottom glass layer 22.

The etched groove 221 is formed on the glass before the glass is curved. The glass can be curved by heating it in a mold. The molds can be arranged in a rotary conveyer orientation. The molds can have a mold body 232 which have a mold concave profile 231. The flat sheet of glass 220, FIG. 8 having the design is placed over the mold concave profile 231, FIG. 9. After heating, the curved sheet of glass 220, FIG. 10 is curved but retains the etched groove 221, FIG. 11.

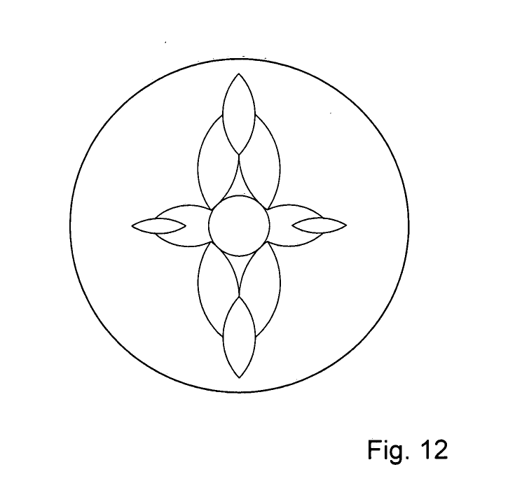

The etching pattern is preferably continuous in a continuous design and continuous groove 221. A variety of geometric shapes including ovals, ellipses and circles can be etched in a surface of the glass to produce a variety of designs, such as that shown in FIG. 12. The etching of the class can be done by a variety of different conventional techniques including digital plotter. Computer control of the etching tool bit is preferred for uniformity, but etching by hand is also possible with hand-held power tools.

Therefore, while the presently preferred form has been shown and described, it is to be understood that the present invention is not limited to the sole embodiment described above, but encompasses any and all embodiments within the scope of the following claims.

1. A double layer cookware comprising:
a. a double layer pot lid comprising: a top glass layer having a top glass layer top surface and a top glass layer bottom surface; and a bottom glass layer having a bottom glass layer top surface and a bottom glass layer bottom surface; wherein the top glass layer bottom surface is etched with a groove or the bottom glass layer top surface is etched with a groove, wherein the top glass layer is installed over the bottom glass layer;
b. a rim having a top section retaining the top glass layer and a lower section retaining the bottom glass layer;
c. a top edge formed on the rim at a top portion of the rim; and
d. a bottom edge formed on the rim at a bottom portion of the rim; and
e. a detachable lid swiveling mechanism for a pot lid.

2. The double layer cookware of claim 1, wherein the lower section retains the bottom glass layer top surface underneath a lower section horizontal wall formed on the lower section, wherein the lower section retains the bottom glass layer bottom surface above a bottom crimp formed on the lower section.

3. The double layer cookware of claim 1, wherein the lower section retains a bottom glass layer outer periphery inside a lower section vertical wall formed on the lower section.

4. The double layer cookware of claim 1, further comprising an upper section vertical wall formed on the upper section, wherein the upper section vertical wall retains a top glass layer outer periphery.

5. The double layer cookware of claim 1, wherein the top edge retains the top glass layer top surface.

6. The double layer cookware of claim 1, further comprising an intermediate indent formed on the lower section, wherein the intermediate indent extends inward between the top glass layer and the bottom glass layer.

7. The double layer cookware of claim 1, further comprising a top seal that seals the top edge to the top glass layer top surface.

8. The double layer cookware of claim 1, further comprising a bottom seal that seals the bottom glass layer top surface to the lower section.

9. The double layer cookware of claim 1, wherein the lower section retains the bottom glass layer top surface underneath a lower section horizontal wall formed on the lower section, wherein the lower section retains the bottom glass layer bottom surface above a bottom crimp formed on the lower section, wherein the lower section retains a bottom glass layer outer periphery inside a lower section vertical wall formed on the lower section.

10. The double layer cookware of claim 9, further comprising a top seal that seals the top edge to the top glass layer top surface.

11. The double layer cookware of claim 1, further comprising an upper section vertical wall formed on the upper section, wherein the upper section vertical wall retains a top glass layer outer periphery, wherein the top edge retains the top glass layer top surface.

12. The double layer cookware of claim 11, further comprising a bottom seal that seals the bottom glass layer top surface to the lower section.

13. The double layer cookware of claim 1, further comprising an intermediate indent formed on the lower section, wherein the intermediate indent extends inward between the top glass layer and the bottom glass layer, further comprising a top seal that seals the top edge to the top glass layer top surface, and further comprising a bottom seal that seals the bottom glass layer top surface to the lower section.

14. The double layer cookware of claim 1, wherein a lower section retains the bottom glass layer top surface underneath a lower section horizontal wall formed on the lower section, wherein the lower section retains the bottom glass layer bottom surface above a bottom crimp formed on the lower section, wherein the lower section retains a bottom glass layer outer periphery inside a lower section vertical wall formed on the lower section, further comprising an upper section vertical wall formed on the upper section, wherein the upper section vertical wall retains a top glass layer outer periphery, wherein the top edge retains the top glass layer top surface.

15. The double layer cookware of claim 14, further comprising a bottom seal that seals the bottom glass layer top surface to the lower section.

16. The double layer cookware of claim 14, further comprising a top seal that seals the top edge to the top glass layer top surface.

17. The double layer cookware of claim 14, further comprising a handle mounted to the top glass layer.

18. The double layer cookware of claim 17, further comprising a pair of handle mount openings formed on the top glass layer, wherein the handle is mounted to the top glass layer at the pair of handle mount openings.
